(19) United States
(12) Patent Application Publication
(10) Pub. No.: US 2019/0049278 A1
(43) Pub. Date: Feb. 14, 2019

(54) THERMAL TYPE FLOWMETER

(71) Applicant: AZBIL CORPORATION, Chiyoda-ku (JP)

(72) Inventors: Yoshio YAMAZAKI, Chiyoda-ku (JP); Shinsuke Matsunaga, Chiyoda-ku (JP); Shigeru Aoshima, Chiyoda-ku (JP)

(73) Assignee: AZBIL CORPORATION, Chiyoda-ku (JP)

(21) Appl. No.: 16/057,083

(22) Filed: Aug. 7, 2018

(30) Foreign Application Priority Data
Aug. 14, 2017 (JP) 2017-156404

(51) Int. Cl. G01F 1/698; G01F 1/684

(52) U.S. Cl. CPC G01F 1/698; G01F 1/6847

(57) ABSTRACT

A thermal type flowmeter includes a sensor, a correcting unit, and a flow-rate calculating unit. The sensor outputs a sensor value (first value) corresponding to the state of thermal if fusion in a fluid heated by a heater which is being driven in such a manner that the difference between the temperature of the heater and the temperature of the fluid at a location free from thermal influence of the heater is equal to a predetermined temperature difference. The correcting unit calculates a corrected sensor value (second value) by correcting the sensor value output by the sensor, in accordance with the temperature of the fluid, and outputs the corrected sensor value. The flow-rate calculating unit calculates the flow rate of the fluid from the corrected sensor value calculated by the correcting unit.

### CROSS-REFERENCE TO RELATED APPLICATIONS

The present application is based on and claims priority to Japanese Application No. 2017-156404, filed Aug. 14, 2017, the entire contents of which are incorporated herein by reference.

### BACKGROUND

### 1. Field

The present disclosure relates to a thermal type flowmeter that measures the flow rate of a fluid using the effect of thermal diffusion in the fluid,

### 2. Description of the Related Art

Techniques that measure the flow rate or velocity of a fluid flowing through a flow path are in widespread use, for example, in the industrial and medical fields. Examples of various devices that measure the flow rate or velocity include electromagnetic flowmeters, vortex flowmeters, Coriolis type flowmeters, and thermal type flowmeters, and different ones are used for different purposes. The thermal type flowmeters are advantageous in that they are capable of detecting gases, basically free from pressure loss, and capable of measuring mass flow rates. With a glass tube serving as a flow path, thermal type flowmeters capable of measuring the flow rate of a corrosive liquid are also used (see, e.g., Japanese Unexamined Patent Application Publication No. 2006-010322, Japanese Unexamined Patent Application Publication (Translation of PCT Application) No. 2003-532099). Thermal type flowmeters that measure the flow rate of a liquid, as described above, are suitable for use in measuring a very small amount of flow.

The thermal type flowmeters are of two different types. One uses a method that measures the flow rate from a difference in temperature between the upstream and downstream sides of the heater, whereas the other uses a method that measures the flow rate from power consumption of the heater. For example in the measurement of the flow rate of a water solution, the heater is driven by heating to a constant temperature 10° C. higher than the water temperature. Then, the flow rate is calculated from a difference in temperature between the upstream and downstream sides of the heater, or from the power of the heater.

The thermal type flowmeters are disadvantageous in that changes in the temperature of a fluid cause errors in the output of the measurement result. When the temperature of a fluid to be measured (which may hereinafter be referred to as “measured fluid”) and the ambient temperature change, for example, the thermal conductivities of the fluid and the region surrounding the detecting unit also change. The changes in temperature cause changes the measurement result and lead to errors in the output of the flow rate.

### SUMMARY

The present disclosure has been made to solve the problems described above. An object of the present disclosure is to accurately measure the flow rate of a fluid to be measured even when the temperature of the fluid changes.

A thermal type flowmeter according; to an aspect of the present disclosure includes a sensor, a correcting unit, and a flow-rate calculating unit. The sensor includes a heater that heats a fluid to be measured. The sensor is configured to output a first value corresponding to a state of thermal diffusion in the fluid heated by the heater which is being driven in such a manner that a difference between a temperature of the heater and a temperature of the fluid at a location free from thermal influence of the heater is equal to a predetermined temperature difference. The correcting unit is configured to calculate a second value by correcting the first value in accordance with the temperature or the fluid. The flow-rate calculating unit is configured to calculate a flow rate of the fluid from the second value calculated by the correcting unit.

In the thermal type flowmeter described above, the correcting unit may use one of the following correction equations, “second value=first value/(1+{first constant×(temperature−reference temperature)})” and “second value=first value/(1+(second constant ×{temperature−reference temperature)²+third constant×(temperature−reference temperature)})”, to correct the first value to determine the second value.

In the thermal type flow meter described above, as the first value, the sensor may output power of the heater which is being driven in such a manner that the difference between the temperature of the heater and the temperature of the fluid at a location free from thermal influence of the heater is constant.

In the thermal type flowmeter described above, as the first value, the sensor may output a temperature difference between a temperature of the fluid upstream of the heater and a temperature of the fluid downstream of the heater which is being* driven in such a manner that the difference between the temperature of the heater and the temperature of the fluid at a location free from thermal influence of the heater is equal to the predetermined temperature difference.

The thermal type flowmeter described above may further include a tube configured to convey the fluid, and a temperature measuring unit disposed in contact with an outer wall of the tube and configured to measure the temperature of the fluid. The heater may be disposed in contact with the outer wail of the tube.

With the configuration described above, the present disclosure ensures accurate measurement of the flow rate even when the temperature of the field to be measured changes.

### BRIEF DESCRIPTION OF THE DRAWINGS

FIG. 1 is a block diagram illustrating a configuration of a thermal type flowmeter according to an embodiment of the present disclosure;

FIG. 2 is a block diagram illustrating a detailed configuration of a sensor in the thermal type flowmeter according to the embodiment of the present disclosure;

FIG. 3 is a block diagram illustrating a detailed configuration of another sensor in the thermal type flowmeter according to the embodiment of the present disclosure;

FIG. 4 is a characteristic diagram showing a relation between a sensor value from the sensor illustrated in FIG. 2 and the flow rate of a measured fluid;

FIG. 5 is a characteristic diagram showing a relation between a corrected sensor value obtained by a correcting unit through correction of the sensor value from the sensor illustrated in FIG. 2 and the flow rate of the measured fluid; and

FIG. 6 is a block diagram illustrating a hardware configuration of the correcting unit and a flow-rate calculating unit according to the embodiment of the present disclosure.

### DETAILED DESCRIPTION

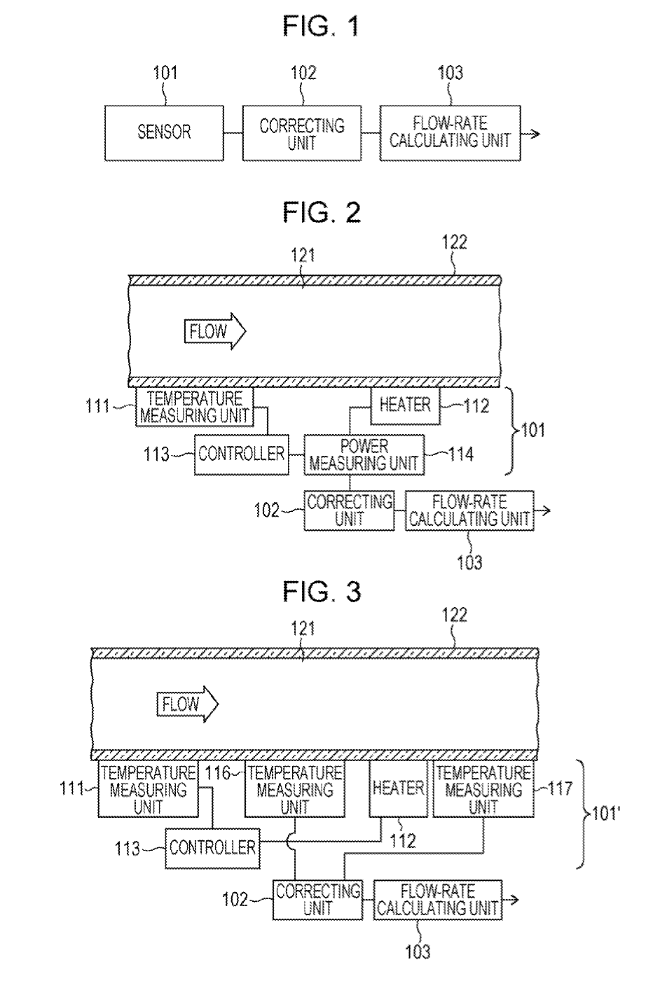

A thermal type flowmeter according to an embodiment of the present disclosure will now be described with reference to the drawings. As illustrated in. FIG. 1, the thermal type flowmeter includes a sensor 101, a correcting unit 102, and a flow-rate calculating unit. 103,

The sensor 101 includes a heater that heats a fluid to be measured (measured fluid). The sensor 101 outputs a sensor value (first value) corresponding to the state of thermal diffusion in the fluid heated by the heater which is being driven in such a manner that the difference between the temperature of the heater and the temperature of the fluid at a location free from the thermal influence of the heater is equal to a predetermined temperature difference. The correcting unit 102 determines a corrected sensor value (second value) by correcting, in accordance with the temperature of the fluid, the sensor value output by the sensor 101 and outputs the corrected sensor value.

The correcting unit 102 uses the correction equation “corrected sensor value=sensor value/(1+{first constant×(temperature−reference temperature)}) . . . (1)” to correct the sensor value output by the sensor 101. Alternatively, the correcting unit 102 uses the correction equation “corrected sensor value=sensor value/(1+{second constant×(temperature−reference temperature)²+third constant×(temperature−reference temperature)}) . . . (2)” to correct the sensor value output by the sensor 101.

The first constant, the second constant, and the third constant may be appropriately determined in advance on the basis of a measurement result obtained by measuring a known flow rate at different temperatures.

The flow-rate calculating unit 103 calculates the flow rate of the fluid from the corrected sensor value (second value) determined by the correcting unit 102. The reference temperature may be appropriately determined in advance by using, for example, a fluid temperature at which the output for a known flow rate is measured, or a temperature at which reference characteristics are defined.

The sensor 101 will now be described in detail. For example, as illustrated in FIG. 2, the sensor 101 includes a temperature measuring unit 111, a heater 112, a controller 113, and a power measuring unit 114. The temperature measuring unit ill is disposed in contact with the outer wall of a tube 122 that conveys a measured fluid 121. The tube 122 is made of, for example, glass. The heater 112 is disposed in contact with the outer wall of the tube 122 on the downstream side of the temperature measuring unit 111. The temperature measuring unit ill measures the temperature of the fluid 121.

The controller 113 controls and drives the heater 112 in such a manner that the difference between the temperature of the heater 112 and the temperature of the fluid 121 measured by the temperature measuring unit 111 at a location free from thermal influence of the heater 112 (e.g., at a location upstream of the heater 112) is equal to a predetermined temperature difference, the power measuring unit 114 measures and outputs the power of the heater 112 controlled by the controller 113. In this example, the power output from the power measuring unit 114 of the sensor 101 is the sensor value (first value). From the power of the heater 112 (i.e., sensor value) measured and output by the power measuring unit 114, the flow rate of the fluid 121 can be calculated.

As is well known, power consumed by the heater 112 has a correlation with the flow rate of the fluid 121 when the heater 112 is being driven in such a manner that the difference between the temperature of the heater 112 and the temperature of the fluid 121 at a location free from thermal influence of the heater 112 is equal to a predetermined temperature difference. This correlation is reproducible under the same fluid, flow rate, and temperature conditions. Therefore, as described above, from the power of the heater 112 measured by the power measuring unit 114 when the heater 112 is being controlled by the controller 113, the flow rate of the fluid 121 can be calculated by using a predetermined correlation factor (constant),

A sensor 101′ illustrated, in FIG. 3 may be used, instead of the sensor 101. The sensor 101′ includes the temperature measuring unit ill, the heater 112, the controller 113 a temperature measuring unit 116 and a temperature measuring unit 117.

The temperature measuring unit 111 is disposed in contact with the outer wail of the tube 122 that conveys the measured fluid 121. The heater 112 is disposed in contact with the outer wall of the tube 122 on the downstream side of the temperature measuring unit 111. The temperature measuring unit ill measures the temperature of the fluid 121.

The controller 113 controls and drives the heater 112 in such a manner that the difference between the temperature of the heater 112 and the temperature of the fluid 121 measured by the temperature measuring unit 111 at a location free from the thermal influence of the heater 112 (e.g., at a location upstream of the heater 112) is equal to a predetermined temperature difference.

The temperature measuring unit 116 is disposed in contact with the outer wall of the tube 122 on the downstream side of the temperature measuring unit 111 and the upstream side of the heater 112. The temperature measuring unit 117 is disposed in contact with the outer wall of the tube 122 on the downstream side of the heater 112. The temperature measuring unit 116 and the temperature measuring unit 117 both measure the temperature of the fluid 121.

The flow rate of the fluid 121 can be calculated from the difference between the fluid temperature measured by the temperature measuring unit 116 and the fluid temperature measured by the temperature measuring unit 117. In this example, the difference between the fluid temperature measured by the temperature measuring unit 116 and the fluid temperature measured by the temperature measuring unit 117 is the sensor value.

As is well known, the temperature difference between the temperature of the fluid 121 upstream of the heater 112 and the temperature of the fluid 121 downstream of the heater 112 has a correlation with the flow rate of the fluid 121 when the heater 112 is being driven in such a manner that the difference between the temperature of the heater 112 and the temperature of the fluid 121 at a location free from thermal influence of the heater 112 is equal to a predetermined temperature difference. This correlation is reproducible under the same fluid, flow rate, and temperature conditions. Therefore, as described above, from the difference (temperature difference) between the temperature measured by the temperature measuring unit 116 and the temperature measured by the: temperature measuring unit 117 when the heater 112 is being controlled by the controller 113, the flow rate of the fluid 121 can be calculated by using a predetermined correlation factor (constant).

A sensor value P from the sensor 101 configured as described above can be expressed as “P={A+B(μ)^{1/2}}×T”, where μ is the flow velocity of the measured fluid, ΔT is the heating temperature of the heater, and A and B are constants. Note that the constants A and B are determined, for example, by the shapes and thermal conductivities of parts and the density, viscosity, and thermal capacity of the measured fluid. As can be seen from this equation, even when the flow velocity (flow rate) is constant, the sensor value P changes as the temperature, density, and viscosity of the measured fluid change.

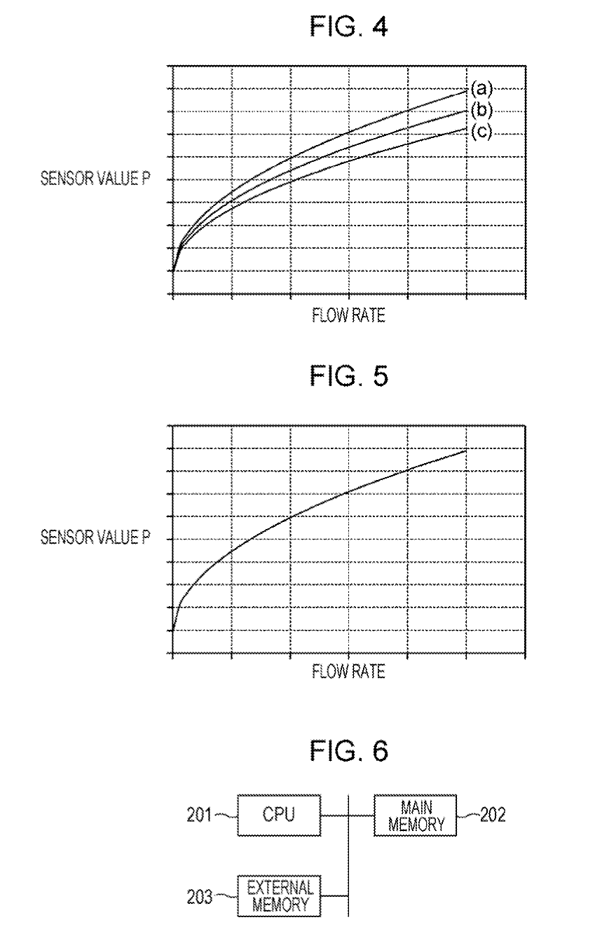

The relation between the sensor value P from the sensor 101 and the flow rate of the measured fluid varies depending on, for example, the temperature of the measured fluid as shown in FIG. 4. The flow rate of water is measured in this example. Note that curve (a) In FIG. 4 represents a relation between the sensor value P and the flow rate of the measured fluid having a temperature of 40° C., curve (b) in FIG. 4 represents a relation between the sensor value P and the flow rate of the measured fluid having a temperature of 30° C., and curve (c) in FIG. 4 represents a relation between the sensor value P and the flow rate of the measured fluid having a temperature of 20° C.

As shown in FIG. 4, depending on the temperature of water whose flow rate is to be measured, the sensor value P corresponding to the same flow rate varies. This is because, for example, the thermal conductivity, and the density vary with temperature. As shown in Table 1 below, the density, specific heat, and thermal conductivity of pure water vary with temperature. As shown in Table 1, the thermal conductivity of water increases with increasing temperature. The sensor value P is highly dependent on the thermal conductivity. This means that the higher the temperature, the larger the sensor value P.

TABLE 1

| | | | Thermal |
|---|---|---|---|
| Temperature | Density | Specific Heat | Conductivity |
| (° C.) | (g/cm³) | (J/kg° C.) | (W/m K) |
| 0 | 0.9999 | 4217 | 0.569 |
| 10 | 0.9997 | 4192 | 0.587 |
| 20 | 0.9982 | 4182 | 0.602 |
| 30 | 0.9957 | 4178 | 0.618 |
| 40 | 0.9923 | 4178 | 0.632 |
| 50 | 0.9881 | 4180 | 0.642 |
| 60 | 0.9832 | 4184 | 0.654 |
| 70 | 0.9778 | 4189 | 0.664 |
| 80 | 0.9718 | 4196 | 0.672 |
| 90 | 0.9653 | 4205 | 0.678 |
| 100 | 0.9584 | 4215 | 0.682 |

In the present embodiment, the correcting unit 102 corrects the sensor value (first value) output from the sensor 101 using equation (1) or 2) on the basis of the temperature of the fluid. From the corrected sensor value (second value) determined by the correcting unit 102, the flow-rate calculating unit 103 calculates the flow rate of the fluid. Thus, even when the temperature of the measured fluid changes, the relation between the sensor value and the flow rate of the measured fluid does not change as shown in FIG. 5.

The correcting unit 102 and the flow-rate calculating unit 103 are computer devices each including, as illustrated in FIG. 6, a central processing unit (CPU) 201, a main memory 202, and an external memory 203. The functions described above are implemented when the CPU 201 operates in accordance with a program expanded in the main memory 202.

As described above, in the present disclosure, the correcting unit calculates the second value by correcting the first value output by the sensor, in accordance with the temperature of the fluid. For example, by using one of the equations “second value=first value/(1+{first constant×(temperature−reference temperature)})” and “second value=first value/(1+(second constant×(temperature−reference temperature)²+third constant×(temperature−reference temperature)})”, the correcting unit calculates the second value by correcting the first value output by the sensor. Thus, the present disclosure ensures accurate measurement of the flow rate even when the temperature of the measured fluid changes.

The present disclosure is not limited to the embodiments described above. It is obvious that, within the technical idea of the present disclosure, various modifications and combinations can be made by those having ordinary knowledge in the art.

What is claimed is:

1. A thermal type flowmeter comprising:
a sensor including a heater that heats a fluid to be measured, the sensor being configured to output a first value corresponding to a state of thermal diffusion in the fluid heated by the heater which is being driven in such a manner that a difference between a temperature of the heater and a temperature of the fluid at a location free from thermal influence of the heater is equal to a predetermined temperature difference;
a correcting unit configured to calculate a second value by correcting the first value in accordance with the temperature of the fluid; and
a flow-rate calculating unit configured to calculate a flow rate of the fluid from the second value calculated by the correcting unit.

2. The thermal type flowmeter according to claim 1, wherein the correcting unit uses one of the following correction equations, “second value=first value/(1+{first constant×(temperature−reference temperature)})” and “second value first value/(1+{second constant×(temperature−reference temperature)²+third constant×(temperature−reference temperature)})”, to correct the first value to determine the second value.

3. The thermal type flowmeter according to claim 1, wherein the sensor outputs power of the heater as the first value, the heater being driven in such a manner that the difference between the temperature of the heater and the temperature of the fluid at a location free from thermal influence of the heater is constant.

4. The thermal type flowmeter according to claim 1, wherein the sensor outputs a temperature difference between a temperature of the fluid upstream of the heater and a temperature of the fluid downstream of the heater as the first value, the heater being driven in such a manner that the difference between the temperature of the heater and the temperature of the fluid at a location free from thermal influence of the heater is equal to the predetermined temperature difference.

5. The thermal type flowmeter according to claim 1, further comprising:
a tube configured to convey the fluid; and
a temperature measuring unit disposed in contact with an outer wall of the tube, the temperature measuring unit being configured to measure the temperature of the fluid,
wherein the heater is disposed in contact with the outer wall of the tube.
